(19) United States
(12) Patent Application Publication
(10) Pub. No.: US 2025/0309581 A1
(43) Pub. Date: Oct. 2, 2025

(54) Electrical Connection Module, Electrical Connection Assembly and Power Connector

(71) Applicant: Tyco Electronics (Shanghai) Co., Ltd., Shanghai (CN)

(72) Inventor: Jiaoyong (Mac) Liu, Shanghai (CN)

(73) Assignee: Tyco Electronics (Shanghai) Co., Ltd., Shanghai (CN)

(21) Appl. No.: 19/091,025

(22) Filed: Mar. 26, 2025

(30) Foreign Application Priority Data
Mar. 27, 2024 (CN) 202410362931.X

(51) Int. Cl. H01R 13/512; H01R 13/533

(52) U.S. Cl. CPC H01R 13/512; H01R 13/533

(57) ABSTRACT

An electrical connection module includes a shell, a terminal arranged in the shell, and a thermal block disposed in the shell. The shell has a front port, an upper shell, a lower shell opposite the upper shell in a height direction of the shell, a front end, and a rear end opposite the front end in a longitudinal direction of the shell. The terminal has an upper terminal and a lower terminal opposite each other in the height direction. The upper terminal and the lower terminal respectively have an upper elastic contact arm and a lower elastic contact arm located in the front port. The thermal block is clamped between the upper terminal and the lower terminal. The upper elastic contact arm and the lower elastic contact arm electrically contact an upper side and a lower side of a mating terminal inserted into the front port.

### CROSS-REFERENCE TO RELATED APPLICATION

This application claims the benefit of the filing date under 35 U.S.C. § 119(a)-(d) of Chinese Patent Application No. CN202410362931.X, filed on Mar. 27, 2024.

### FIELD OF THE INVENTION

The present invention relates to an electrical connection module, an electrical connection assembly comprising the electrical connection module and a power connector comprising the electrical connection assembly.

### BACKGROUND OF THE INVENTION

A power connector typically includes an insulation housing and an electrical connection module installed in the insulation housing. The electrical connection module typically includes a metal shell and upper and lower terminals arranged in the metal shell. One end of the upper terminal and one end of the lower terminal make electrical contact with the mating terminal inserted into the metal shell, and the other end of the upper terminal and the other end of the lower terminal are fastened to one end of the power transmission component.

The metal shell is often an integral piece, and the distance between its top and bottom walls is fixed and unchanged. This results in a size of a gap between the upper and lower terminals not being adjustable. Therefore, when it is necessary to match with mating terminals of different thicknesses, it is necessary to manufacture metal shells of different sizes, which leads to increased costs.

In addition, the other end of the upper terminal and the other end of the lower terminal are usually fastened to one end of the power transmission component using bolts and nuts. To ensure the reliability of the connection, it is usually necessary to rivet the nut onto the metal shell to prevent the nut from being moved. However, riveting the nut onto the metal shell requires the use of specialized riveting tools, which also increases costs.

### SUMMARY OF THE INVENTION

An electrical connection module includes a shell, a terminal arranged in the shell, and a thermal block disposed in the shell. The shell has a front port, an upper shell, a lower shell opposite the upper shell in a height direction of the shell, a front end, and a rear end opposite the front end in a longitudinal direction of the shell. The terminal has an upper terminal and a lower terminal opposite each other in the height direction. The upper terminal and the lower terminal respectively have an upper elastic contact arm and a lower elastic contact arm located in the front port. The thermal block is clamped between the upper terminal and the lower terminal. The upper elastic contact arm and the lower elastic contact arm electrically contact an upper side and a lower side of a mating terminal inserted into the front port.

### BRIEF DESCRIPTION OF DRAWINGS

The invention will now be described by way of example with reference to the accompanying figures, of which:

FIG. 1 is a perspective view of an electrical connection module according to an exemplary embodiment;

FIG. 2 is a sectional perspective view of the electrical connection module of FIG. 1;

FIG. 3 is a sectional perspective view of the electrical connection module of FIG. 1 with one fastener not yet installed;

FIG. 4 is a sectional side view of the electrical connection module of FIG. 1;

FIG. 5 is a sectional perspective view of the electrical connection module of FIG. 1;

FIG. 6 is a perspective view of a thermal block of the electrical connection module of FIG. 1;

FIG. 7 is a perspective view of either upper terminals or lower terminals of the electrical connection module of FIG. 1;

FIG. 8 is an exploded view of the upper terminals or lower terminals of FIG. 7;

FIG. 9 is an exploded view of an upper shell and a lower shell of the electrical connection module of FIG. 1;

FIG. 10 is a perspective view of the upper shell of FIG. 9 and a connection block of the electrical connection module of FIG. 1;

FIG. 11 is a perspective view of an electrical connection module according to another exemplary embodiment; and

FIG. 12 is an exploded view of the electrical connection module of FIG. 11.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

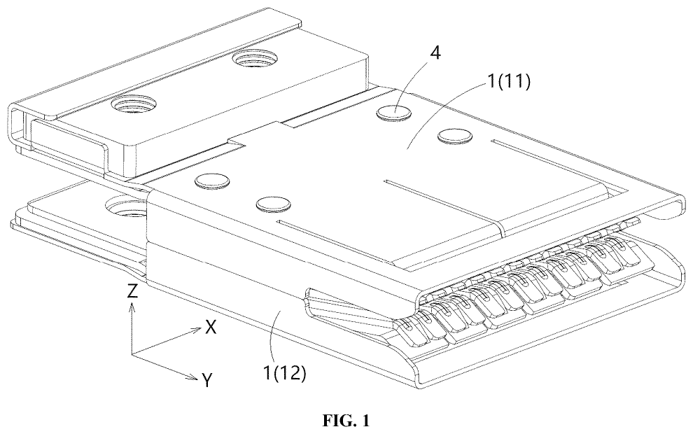

An exemplary embodiment of an electrical connection module is now described with reference to FIGS. 1-10.

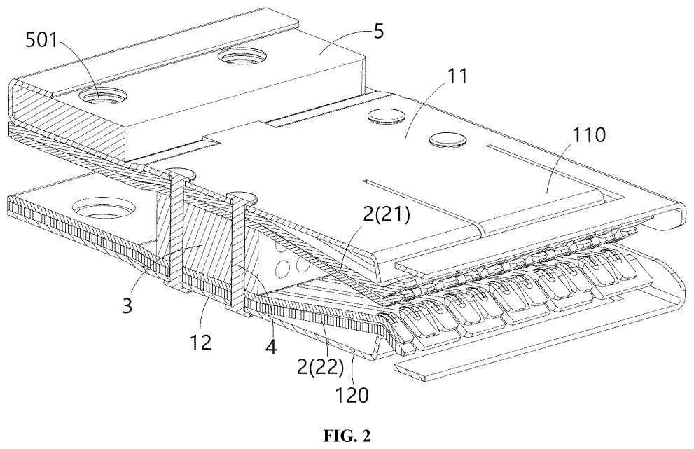

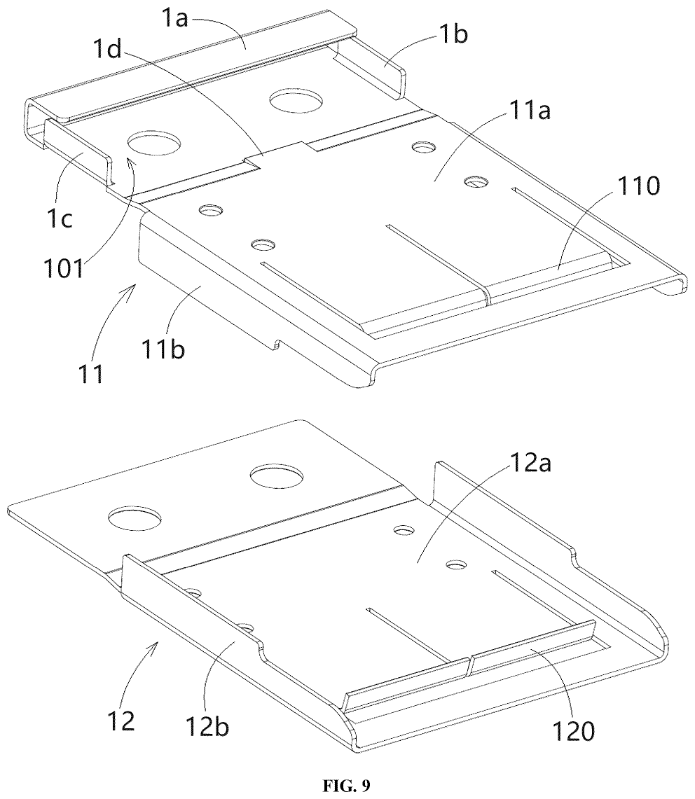

The electrical connection module comprises a shell 1, a terminal 2, a thermal block 3, and a fastener 4. As shown in FIGS. 1-4 and 9, the shell 1 includes an upper shell 11 and a lower shell 12 that are opposite in a height direction Z of the shell 1. As shown in FIGS. 2-4, the terminal 2 is located in the shell 1 and includes an upper terminal 21 and a lower terminal 22 that are opposite in the height direction Z. As shown in FIGS. 2-4, the thermal block 3 is set in the shell 1 and clamped between the upper terminal 21 and the lower terminal 22. The fastener 4, as shown in FIGS. 1-4, penetrates through the shell 1, the terminal 2, and the thermal block 3 along the height direction Z. As shown in FIG. 9, the shell 1 has a top wall 11a and bottom wall 12a. As shown in FIG. 2, two ends of the fastener 4 are respectively fixed to the top wall 11a and bottom wall 12a of shell 1 to fasten the shell 1, the terminal 2, and the thermal block 3 together.

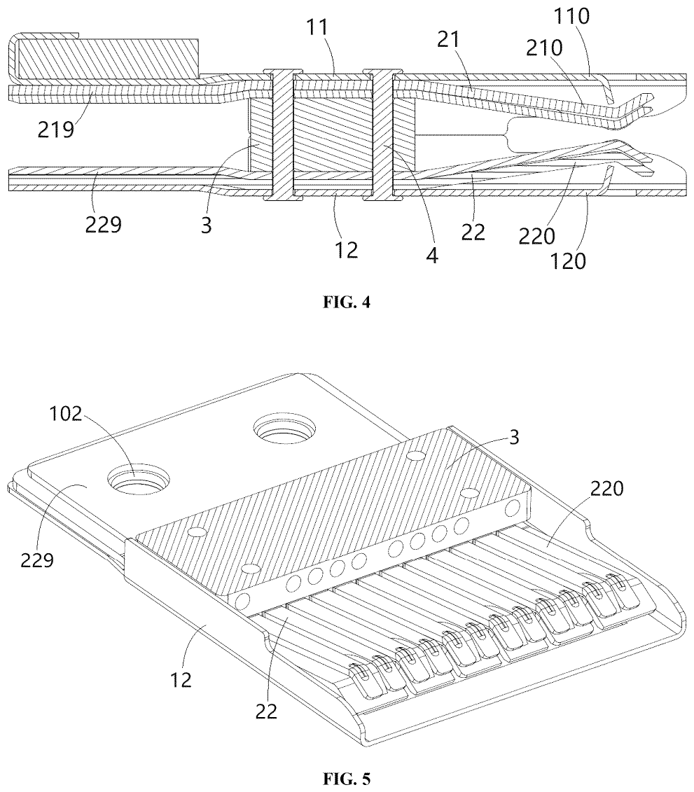

As shown in FIG. 1, the shell 1 has front and rear ends that are opposite in a longitudinal direction Y of the shell 1. As shown in FIG. 4, the upper terminal 21 and the lower terminal 22 respectively have upper elastic contact arms 210 and lower elastic contact arms 220 located in the front port of the shell 1. The upper elastic contact arms 210 and the lower elastic contact arms 220 are used to make electrical contact with the upper and lower sides of the mating terminal inserted into the front port of the shell 1.

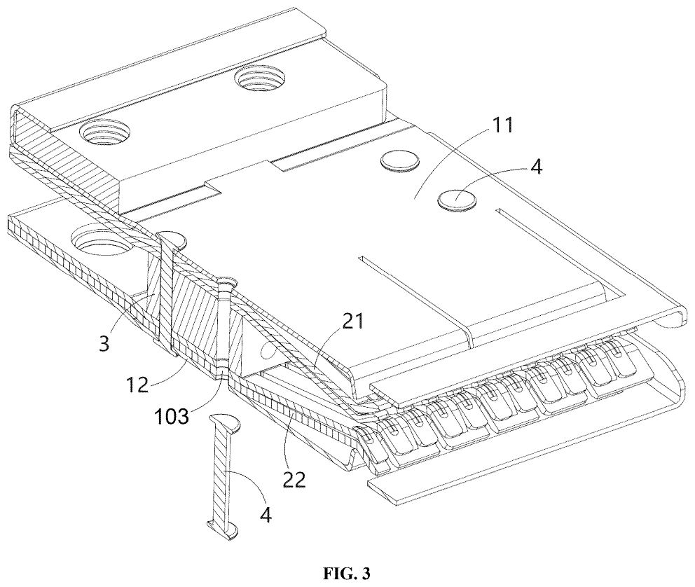

As shown in FIG. 3, through holes 103 are respectively formed in the shell 1, the terminal 2, and the thermal block 3 to allow the fastener 4 to pass through. The two ends of the fastener 4 extend from the through holes 103 on the top wall 11a and bottom wall 12a of the shell 1 and are respectively fixed to the top wall 11a and bottom wall 12a of the shell 1.

As shown in FIGS. 1-4, the fastener 4 includes a rivet pin, which penetrates through the shell 1, the terminal 2, and the thermal block 3 along the height direction Z, and its two ends are respectively riveted to the top wall 11a and bottom wall 12a of the shell 1. However, the present invention is not limited to the illustrated embodiment. For example, in another exemplary embodiment of the present invention, the fastener 4 may include a bolt and a nut. The bolt penetrates through the shell 1, the terminal 2, and the thermal block 3 along the height direction Z, and one end of the bolt extends to the outside of the top wall 11a or bottom wall 12a of the shell 1 and is threaded with the nut.

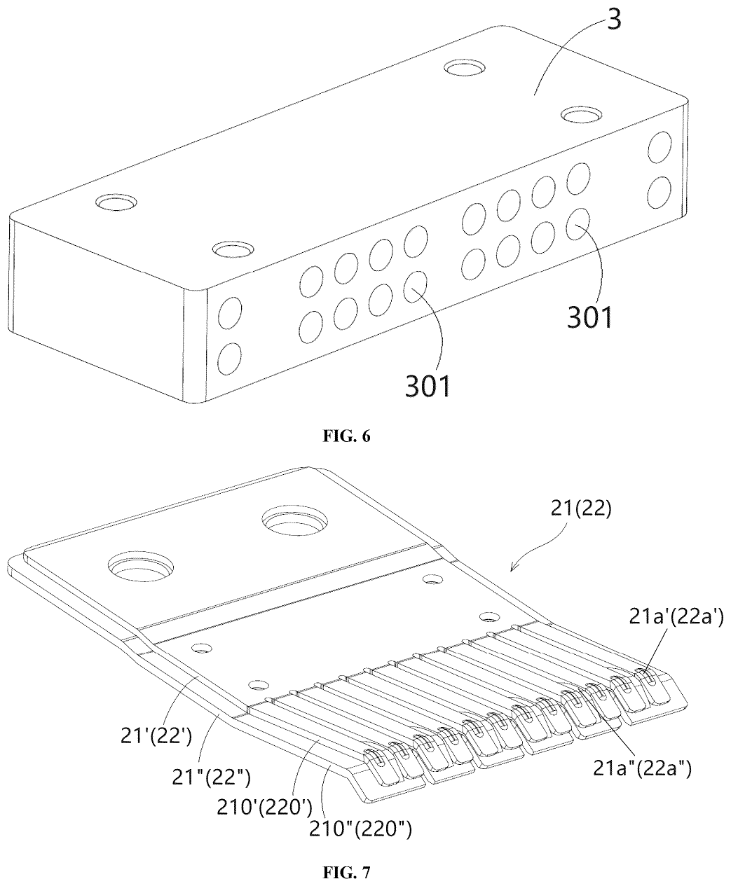

As shown in FIG. 6, multiple longitudinal holes 301 are formed in the thermal block 3. The multiple longitudinal holes 301 penetrate through the thermal block 3 longitudinally, resulting in a honeycomb shaped cross-section of the thermal block 3. In this way, the heat dissipation capacity of the thermal block 3 can be improved.

As shown in FIG. 9, the shell 1 has a pair of opposite side walls 11b, 12b in a transverse direction X of the shell 1. The thermal block 3, as shown in FIG. 6, has two opposite side surfaces in the transverse direction X. The two side surfaces of the thermal block 3 are respectively pressed against the inner side surfaces of the pair of side walls 11b, 12b of the shell 1. In this way, heat can be quickly transferred to the shell 1.

As shown in FIG. 9, the upper shell 11 includes a top wall 11a and a pair of upper side walls 11b located on both sides of the top wall 11a. The lower shell 12, as shown in FIG. 9, includes a bottom wall 12a and a pair of lower side walls 12b located on both sides of the bottom wall 12a. The pair of upper side walls 11b and the pair of lower side walls 12b constitute a pair of side walls 11b, 12b of the shell 1.

As shown in FIG. 9, upper and lower elastic pressing arms 110 and 120 are respectively formed on the top wall 11a and bottom wall 12a of the shell 1. The ends of the upper and lower elastic pressing arms 110 and 120 are respectively pressed against the outer sides of the upper and lower elastic contact arms 210 and 220 to increase the electrical contact force between the upper elastic contact arms 210 and the mating terminal and the electrical contact force between the lower elastic contact arms 220 and the mating terminal.

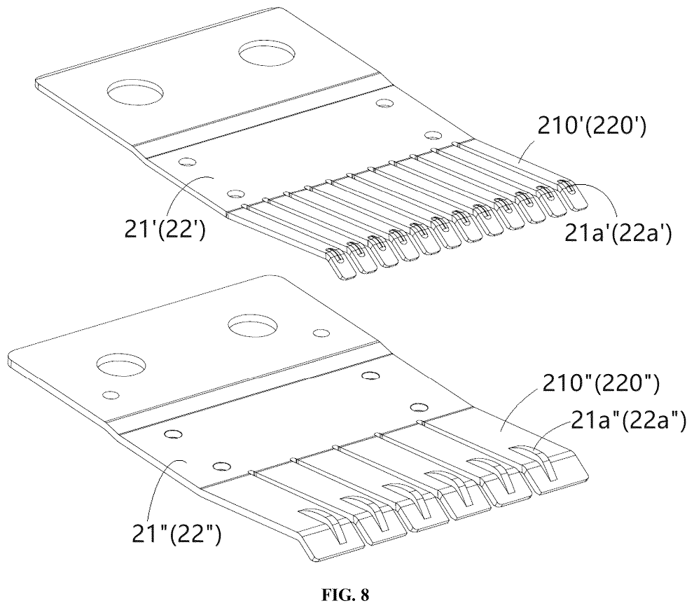

As shown in FIGS. 7-8, the upper terminal 21 includes a sheet-like first main terminal 21′ and a sheet-like first auxiliary terminal 21″, and the first auxiliary terminal 21″ is stacked on the outer side of the first main terminal 21′. The upper elastic contact arm 210 includes a row of first main elastic contact arms 210′ formed on the first main terminal 21′ and a row of first auxiliary elastic contact arms 210″ formed on the first auxiliary terminal 21″. As shown in FIG. 8, on the first main elastic contact arm 210′ and the first auxiliary elastic contact arm 210″, there are first main contact points 21a′ and first auxiliary contact points 21a″, respectively. As shown in FIG. 7, the first auxiliary contact point 21a″ protrudes from the gap between adjacent first main elastic contact arms 210′ to make electrical contact with the mating terminal together with the first main contact point 21a′.

As shown in FIG. 7, the first auxiliary elastic contact arm 210″ is adapted to rest against the outer side of the first main elastic contact arm 210′ to increase the electrical contact force between the first main contact point 21a′ of the first main elastic contact arm 210′ and the mating terminal.

As shown in FIG. 9, an upper elastic pressing arm 110 is formed on the top wall 11a of the upper shell 11. The end of the upper elastic pressing arm 110 is pressed against the outer side of the first auxiliary elastic contact arm 210″ to increase the electrical contact force between the first main elastic contact arm 210′ and the mating terminal and the electrical contact force between the first auxiliary elastic contact arm 210″ and the mating terminal.

As shown in FIGS. 7-8, the lower terminal 22 includes a sheet-like second main terminal 22′ and a sheet-like second auxiliary terminal 22″, with the second auxiliary terminal 22″ stacked on the outer side of the second main terminal 22′. The lower elastic contact arm 220 includes a row of second main elastic contact arms 220′ formed on the second main terminal 22′ and a row of second auxiliary elastic contact arms 220″ formed on the second auxiliary terminal 22″. As shown in FIG. 8, on the second main elastic contact arm 220′ and the second auxiliary elastic contact arm 220′, there are second main contact points 22a′ and second auxiliary contact points 22a″, respectively. As shown in FIG. 7, the second auxiliary contact point 22a″ protrudes from the gap between adjacent two second main elastic contact arms 220′ to make electrical contact with the mating terminal together with the second main contact point 22a′.

As shown in FIG. 7, the second auxiliary elastic contact arm 220″ is adapted to rest against the outer side of the second main elastic contact arm 220′ to increase the electrical contact force between the second main contact point 22a′ of the second main elastic contact arm 220′ and the mating terminal.

As shown in FIG. 9, a lower elastic pressing arm 120 is formed on the bottom wall 12a of the lower shell 12. The end of the lower elastic pressing arm 120 is pressed against the outer side of the second auxiliary elastic contact arm 220″ to increase the electrical contact force between the second main elastic contact arm 220′ and the mating terminal and the electrical contact force between the second auxiliary elastic contact arm 220″ and the mating terminal.

As shown in FIGS. 2-4 and 7-8, the upper terminal 21 and the lower terminal 22 are completely identical and can be used interchangeably. This can reduce manufacturing costs.

The shell 1 is made of a first metal material, and the terminal 2 is made of a second metal material. The mechanical properties of the first metal material are superior to those of the second metal material, and the electrical conductivity of the second metal material is superior to that of the first metal material. In the illustrated embodiment, the shell 1 is made of stainless steel, the terminal 2 is made of copper, and the thermal block 3 is made of aluminum.

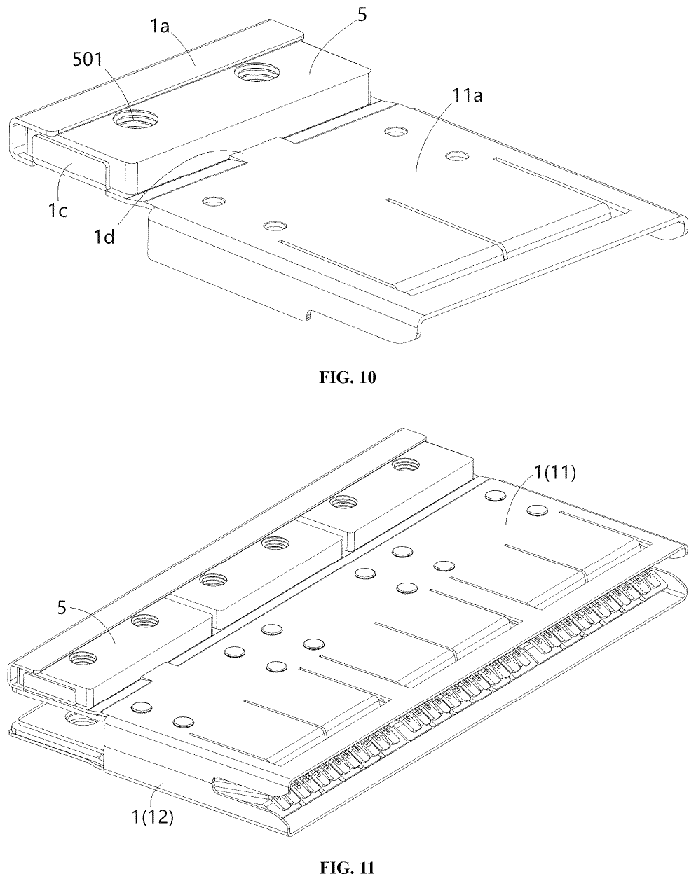

As shown in FIGS. 2 and 10, the electrical connection module further comprises a connection block 5, in which a threaded hole 501 suitable for threaded connection with a threaded connection member is formed.

As shown in FIG. 9, a limiting structure for fixing the connection block 5 is formed on the top wall 11a or bottom wall 12a of the shell 1, and the connection block 5 is fixed to the outer side of the top wall 11a or bottom wall 12a of the shell 1 through the limiting structure. Connection holes 102 are respectively formed in the terminal 2, as shown in FIG. 5, and the shell 1 to allow the threaded connection member to pass through, so that terminal 2 can be fastened to one end of the power transmission component through the threaded connection member that passes through the connection holes 102 and is threaded with the threaded hole 501.

As shown in FIG. 4, the upper terminal 21 and the lower terminal 22 respectively have an upper connection part 219 and a lower connection part 229 located in the rear port of the shell 1. The upper connection part 219 and the lower connection part 229 are suitable for being respectively fastened to the upper and lower sides of one end of the power transmission component through threaded connection members.

As shown in FIG. 9, the limiting structure includes a limit slot 101 formed on the top wall 11a of the upper shell 11. The connection block 5 is accommodated and fixed in the limit slot 101, so that the connection block 5 cannot be rotated or moved relative to the upper shell 11.

As shown in FIG. 9, a rear flange 1a, a left flange 1b, and a right flange 1c are formed on the rear, left, and right sides of the top wall 11a of the upper shell 11, respectively. The rear flange 1a, the left flange 1b and the right flange 1c are upward folded. A limit protrusion 1d is formed on the top wall 11a of the upper shell 11 opposite to the rear flange 1a. The limit slot 101 is defined by the rear flange 1a, the left flange 1b, the right flange 1c and the limit protrusion 1d.

As shown in FIG. 10, the rear flange 1a is folded upward and backward relative to the top wall 11a of the upper shell 11, and the rear flange 1a is simultaneously pressed against the rear side and top surface of the connection block 5. The right flange 1c, limit protrusion 1d, as shown in FIG. 10, and the left flange 1b, are respectively pressed against the left side, right side, and front side of the connection block 5.

As shown in FIGS. 2 and 10, multiple threaded holes 501 are formed in the connection block 5 for threaded connection with multiple threaded connection members, and multiple connection holes 102 are formed in the terminal 2, as shown in FIG. 5, and the shell 1 to allow multiple threaded connection members to pass through. The terminal 2 is fastened to one end of the power transmission component through multiple threaded connection members.

An exemplary embodiment of an electrical connection assembly is now described. The electrical connection assembly includes an electrical connection module, a power transmission component, and a threaded connection member. One end of the power transmission component is inserted between one end of the upper terminal 21 and one end of the lower terminal 22. The threaded connection member penetrates through the shell 1 and the terminal 2 and is threaded to the connection block 5 fixed on the top wall 11a or bottom wall 12a of the shell 1, in order to fasten one end of the upper terminal 21 and one end of the lower terminal 22 to one end of the power transmission component, respectively.

The power transmission component can be a power cable or a connection terminal connected to one end of the power cable, such as a copper bar welded or crimped to one end of the power cable.

An exemplary embodiment of a power connector is now described. The power connector includes an insulation housing and the aforementioned electrical connection assembly. The electrical connection assembly is mounted in the insulation housing, and the power transmission component is led out from the insulation housing.

The electrical connection module can expand in the thickness direction (i.e., the height direction of the shell 1). For example, by quickly replacing thermal blocks of different thicknesses, the electrical connection module can be matched with mating terminals of different thicknesses. In the prior art, it is necessary to remanufacture a shell, which requires the development of new molds for manufacturing the shell, resulting in increased costs and lower production efficiency.

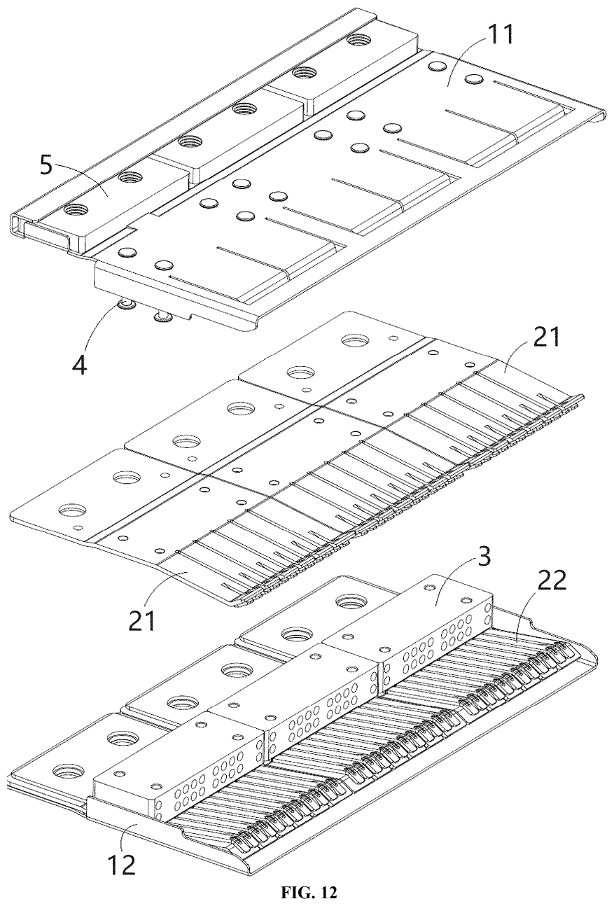

In addition, the electrical connection module of the present invention can also be expanded in the width direction (i.e., the transverse direction of the shell 1). An exemplary embodiment of an electrical connection module expanding in the width direction is now described with reference to FIGS. 11-12.

As shown in FIGS. 11-12, the electrical connection module comprises a shell 1, multiple terminals 2, multiple thermal blocks 3, and multiple sets of fasteners 4. The shell 1 includes an upper shell 11 and a lower shell 12 that are opposite in a height direction Z of the shell 1. Multiple terminals 2 are arranged side by side in a transverse direction X of the shell 1. As shown in FIG. 12, each terminal 2 includes an upper terminal 21 and a lower terminal 22 that are opposite in the height direction Z. Multiple thermal blocks 3, as shown in FIG. 12, are arranged side by side in the transverse direction X of the shell 1 and are respectively clamped between the upper terminals 21 and the lower terminals 22 of the multiple terminals 2. Each set of fasteners 4, as shown in FIG. 11, penetrates through the shell 1, corresponding terminal 2, and corresponding thermal block 3 along the height direction Z. Two ends of each of the fasteners 4 are respectively fixed to the top wall 11a and bottom wall 12a of the shell 1 to fasten the shell 1, corresponding terminal 2, and corresponding thermal block 3 together.

As shown in FIGS. 11-12, the electrical connection module includes multiple connection blocks 5 arranged side by side along the transverse direction X of the shell 1. Multiple terminals 2 can be fastened to one end of the power transmission component through multiple threaded connection members that are respectively connected to multiple connection blocks 5.

However, the present invention is not limited to the illustrated embodiments. For example, another exemplary embodiment of the electrical connection module is now described. The another exemplary embodiment of the electrical connection module includes a shell 1, multiple terminals 2, a single thermal block 3, and multiple sets of fasteners 4. The shell 1 includes an upper shell 11 and a lower shell 12 that are opposite in the height direction Z of the shell 1. Multiple terminals 2 are arranged side by side in the transverse direction of the shell 1, and each terminal 2 includes an upper terminal 21 and a lower terminal 22 that are opposite in the height direction Z. A single thermal block 3 extends along the transverse direction X of the shell 1 and is clamped between the upper terminals 21 and the lower terminals 22 of multiple terminals 2. Each set of fasteners 4 penetrates the shell 1, corresponding terminal 2, and thermal block 3 along the height direction Z, and two ends of each fastener 4 are respectively fixed to the top wall 11a and bottom wall 12a of the shell 1 to fasten the shell 1, corresponding terminal 2, and thermal block 3 together.

In the aforementioned exemplary embodiments according to the present invention, the shell 1 of the electrical connection module includes a separate upper shell 11 and lower shell 12. Therefore, the spacing between the top wall 11a and the bottom wall 12a of the shell 1 can be adjusted according to the thickness of the mating terminal, without the need to manufacture shells of different sizes, thereby reducing manufacturing costs.

In addition, in the aforementioned exemplary embodiments of the present invention, a limiting structure for fixing the connection block 5 is formed on the top wall 11a or the bottom wall 12a of the shell 1, and a threaded hole 501 suitable for threaded connection with the threaded connection member is formed in the connection block 5, so that the terminal 2 of the electrical connection module can be fastened to the power transmission component through the threaded connection member and the connection block 5. Therefore, the present invention does not need to rivet nuts on the shell 1 for connecting with threaded connection members, thereby further reducing manufacturing costs.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. An electrical connection module, comprising:
a shell having a front port, an upper shell, a lower shell opposite the upper shell in a height direction of the shell, a front end, and a rear end opposite the front end in a longitudinal direction of the shell;
a terminal arranged in the shell, the terminal having an upper terminal and a lower terminal opposite each other in the height direction, the upper terminal and the lower terminal respectively have an upper elastic contact arm and a lower elastic contact arm located in the front port; and
a thermal block disposed in the shell and clamped between the upper terminal and the lower terminal, the upper elastic contact arm and the lower elastic contact arm electrically contact an upper side and a lower side of a mating terminal inserted into the front port.

2. The electrical connection module of claim 1, further comprising a fastener inserted through the shell, the terminal, and the thermal block along the height direction, a pair of ends of the fastener are respectively fixed to a top wall and a bottom wall of the shell to fasten the shell, the terminal, and the thermal block together.

3. The electrical connection module of claim 2, wherein the fastener is inserted through a plurality of through holes formed in the shell, the terminal, and the thermal block, the pair of ends of the fastener extend from the through holes on the top wall and the bottom wall of the shell and are respectively fixed to the top wall and the bottom wall of the shell.

4. The electrical connection module of claim 2, wherein the fastener is a rivet pin, a pair of ends of the rivet pin are respectively riveted to the top wall and the bottom wall of the shell.

5. The electrical connection module of claim 2, wherein the fastener is a bolt and a nut, one end of the bolt extends to the outside of the top wall or the bottom wall of the shell and is threaded with the nut.

6. The electrical connection module of claim 2, wherein a plurality of longitudinal holes extending along the longitudinal direction are formed in the thermal block, the thermal block has a honeycomb shaped cross-section.

7. The electrical connection module of claim 1, wherein the shell has a pair of opposite side walls in a transverse direction of the shell, and the thermal block has a pair of opposite side surfaces in the transverse direction, the opposite side surfaces of the thermal block are attached to a pair of inner side surfaces of the pair of opposite side walls of the shell, the upper shell includes a top wall of the shell and a pair of upper side walls located on both sides of the top wall, and the lower shell includes a bottom wall of the shell and a pair of lower side walls located on both sides of the bottom wall.

8. The electrical connection module of claim 2, wherein an upper elastic pressing arm and a lower elastic pressing arm are respectively formed on the top wall and the bottom wall of the shell, an end of the upper elastic pressing arm and an end of the lower elastic pressing arm are respectively pressed against an outer side of the upper elastic contact arm and an outer side of the lower elastic contact arm to increase an electrical contact force between the upper elastic contact arm and the mating terminal and an electrical contact force between the lower elastic contact arm and the mating terminal.

9. The electrical connection module of claim 1, wherein the upper terminal has a first main terminal and a first auxiliary terminal, the first main terminal and the first auxiliary terminal are both sheet-like, the first auxiliary terminal is stacked on an outer side of the first main terminal, the upper elastic contact arm has a row of first main elastic contact arms formed on the first main terminal and a row of first auxiliary elastic contact arms formed on the first auxiliary terminal, a first main contact point and a first auxiliary contact point are respectively formed on each of the first main elastic contact arms and each of the first auxiliary elastic contact arms, the first auxiliary contact point protrudes from a gap between adjacent first main elastic contact arms, the first auxiliary contact point and the first main contact point electrically contact the mating terminal.

10. The electrical connection module of claim 9, wherein the first auxiliary elastic contact arm rests on an outer side of the first main elastic contact arm to increase an electrical contact force between the first main contact point of the first main elastic contact arm and the mating terminal, an upper elastic pressing arm is formed on a top wall of the upper shell, and an end of the upper elastic pressing arm is pressed against an outer side of the first auxiliary elastic contact arm to increase an electrical contact force between the first main elastic contact arm and the mating terminal and an electrical contact force between the first auxiliary elastic contact arm and the mating terminal.

11. The electrical connection module of claim 1, wherein the lower terminal has a second main terminal and a second auxiliary terminal, the second main terminal and the second auxiliary terminal are both sheet-like, the second auxiliary terminal is stacked on an outer side of the second main terminal, the lower elastic contact arm has a row of second main elastic contact arms formed on the second main terminal and a row of second auxiliary elastic contact arms formed on the second auxiliary terminal, a second main contact point and a second auxiliary contact point are respectively formed on each of the second main elastic contact arms and each of the second auxiliary elastic contact arms, the second auxiliary contact point protrudes from a gap between adjacent second main elastic contact arms, the second auxiliary contact point and the second main contact point electrically contact the mating terminal.

12. The electrical connection module of claim 11, wherein the second auxiliary elastic contact arm rests on an outer side of the second main elastic contact arm to increase an electrical contact force between the second main contact point of the second main elastic contact arm and the mating terminal, a lower elastic pressing arm is formed on a bottom wall of the lower shell, and an end of the lower elastic pressing arm is pressed against an outer side of the second auxiliary elastic contact arm to increase an electrical contact force between the second main elastic contact arm and the mating terminal and an electrical contact force between the second auxiliary elastic contact arm and the mating terminal.

13. The electrical connection module of claim 1, further comprising a connection block formed with a threaded hole for threaded connection with a threaded connection member, a limiting structure for fixing the connection block is formed on a top wall or a bottom wall of the shell, the connection block is fixed to an outer side of the top wall or the bottom wall of the shell through the limiting structure, the threaded connection member is inserted through a plurality of connection holes formed in the shell and the terminal to fasten the terminal to an end of a power transmission component.

14. The electrical connection module of claim 13, wherein the upper terminal and the lower terminal respectively have an upper connection part and a lower connection part located in a rear port of the shell, the upper connection part and the lower connection part are respectively fastened to an upper side and a lower side of the end of the power transmission component through the threaded connection member.

15. The electrical connection module of claim 13, wherein the limiting structure has a limit slot formed on a top wall of the upper shell, and the connection block is accommodated and fixed in the limit slot preventing the connection block from being rotated or moved relative to the upper shell.

16. The electrical connection module of claim 15, wherein a rear flange, a left flange, and a right flange that are folded upward are respectively formed on a rear side, a left side, and a right side of the top wall of the upper shell, and a limit protrusion opposite the rear flange is formed on the top wall of the upper shell, the limit slot is defined by the rear flange, the left flange, the right flange, and the limit protrusion.

17. The electrical connection module of claim 16, wherein the rear flange is folded upward and backward relative to the top wall of the upper shell, the rear flange presses against a rear surface and a top surface of the connection block, the left flange, the right flange, and the limit protrusion are respectively pressed against a left side, a right side, and a front side of the connection block.

18. The electrical connection module of claim 13, wherein the electrical connection module has a plurality of terminals arranged side by side along a transverse direction of the shell, a plurality of thermal blocks arranged side by side along the transverse direction, and a plurality of connection blocks arranged side by side along the transverse direction, the plurality of thermal blocks are respectively clamped between upper terminals and lower terminals of the plurality of terminals, and the plurality of terminals are fastened to the end of the power transmission component through a plurality of threaded connection members respectively threaded with the plurality of connection blocks.

19. The electrical connection module of claim 13, wherein the electrical connection module has a plurality of terminals arranged side by side along a transverse direction of the shell, a single thermal block extending along the transverse direction, and a plurality of connection blocks arranged side by side along the transverse direction, the single thermal block is clamped between upper terminals and lower terminals of the plurality of terminals, and the plurality of terminals are fastened to the end of the power transmission component through a plurality of threaded connection members respectively threaded with the plurality of connection blocks.

20. An electrical connection assembly, comprising:
an electrical connection module including a shell having a front port, an upper shell, a lower shell opposite the upper shell in a height direction of the shell, a front end, and a rear end opposite the front end in a longitudinal direction of the shell, a terminal arranged in the shell having an upper terminal and a lower terminal opposite each other in the height direction, the upper terminal and the lower terminal respectively have an upper elastic contact arm and a lower elastic contact arm located in the front port, and a thermal block disposed in the shell and clamped between the upper terminal and the lower terminal, the upper elastic contact arm and the lower elastic contact arm electrically contact an upper side and a lower side of a mating terminal inserted into the front port;
a power transmission component, an end of the power transmission component is inserted between an end of the upper terminal and an end of the lower terminal; and
a threaded connection member inserted through the shell and the terminal, the threaded connection member is threaded to a connection block fixed on a top wall or a bottom wall of the shell, the threaded connection member fastens the end of the upper terminal and the end of the lower terminal to the end of the power transmission component.

21. A power connector, comprising:
an insulative housing; and
an electrical connection assembly mounted in the insulative housing, including:
an electrical connection module including a shell having a front port, an upper shell, a lower shell opposite the upper shell in a height direction of the shell, a front end, and a rear end opposite the front end in a longitudinal direction of the shell, a terminal arranged in the shell having an upper terminal and a lower terminal opposite each other in the height direction, the upper terminal and the lower terminal respectively have an upper elastic contact arm and a lower elastic contact arm located in the front port, and a thermal block disposed in the shell and clamped between the upper terminal and the lower terminal, the upper elastic contact arm and the lower elastic contact arm electrically contact an upper side and a lower side of a mating terminal inserted into the front port;
a power transmission component led out from the insulative housing, an end of the power transmission component is inserted between an end of the upper terminal and an end of the lower terminal; and
a threaded connection member inserted through the shell and the terminal, the threaded connection member is threaded to a connection block fixed on a top wall or a bottom wall of the shell, the threaded connection member fastens the end of the upper terminal and the end of the lower terminal to the end of the power transmission component.
